(19) United States
(12) Patent Application Publication
(10) Pub. No.: US 2011/0059801 A1
(43) Pub. Date: Mar. 10, 2011

(54) NETWORK GAME SYSTEM, NETWORK GAME SYSTEM CONTROL METHOD, GAME CONTROL DEVICE, AND INFORMATION STORAGE MEDIUM

(75) Inventors: Yoshinori SHIIGI, Tokyo (JP); Atsushi MIZUTANI, Chiba (JP); Takeshi MORIZUMI, Chiba (JP)

(73) Assignee: KONAMI DIGITAL ENTERTAINMENT CO., LTD., Tokyo (JP)

(21) Appl. No.: 12/875,717

(22) Filed: Sep. 3, 2010

(30) Foreign Application Priority Data
Sep. 7, 2009 (JP) 2009-206436

(51) Int. Cl. A63F 9/24; A63F 13/06

(52) U.S. Cl. 463/42; 463/43; 463/36

(57) ABSTRACT

A first game character control section controls the action of a first game character which is an operation target for a user, based on an operation carried out by the user. A second game character control section controls the action of one or more second game characters, based on the action control data. In a case where a chat message is input in any game device, addressed to one or more users of one or more other game devices, an action control data changing section changes the action control data, based on the chat message.

### CROSS-REFERENCE TO RELATED APPLICATION

The present application claims priority from Japanese application JP2009-206436 filed on Sep. 7, 2009, the content of which is hereby incorporated by reference into this application.

### BACKGROUND OF THE INVENTION

1. Field of the Invention

The present invention relates to a network game system, a network game system control method, a game control device, and an information storage medium.

2. Description of the Related Art

There is known a game in which a plurality of first game characters, which are operation targets for a plurality of users, and one or more second game characters act. For example, there is known a network game system which carries out a soccer game between a soccer team (a user team) cooperatively operated by a plurality of users and an opponent team. If, e.g., three users cooperatively operate the user team in such a network game system, three of the player characters (first game characters) belonging to the user team are respectively operated by the three users, while the other player characters (second game characters) are operated by a computer (CPU).

A network game system may have a chat function (e.g., JP2009-39305A). For example, if there is a chat function in a network game system such as is described above in which a plurality of users cooperatively operate the user team, a plurality of users can play a game while communicating with one another about strategy of the user team, using the chat function.

### SUMMARY OF THE INVENTION

For example, if a plurality of users cooperatively operate a user team, as described above, and each of the users operates their operation target player character according to the content of a chat (e.g., strategy decided in a chat and so forth), the content of the chat is reflected in actions of the player characters. However, the content of the chat among the users is not reflected in an action of the player character operated by the computer. As a result, the player character operated by the computer may not act according to the content of the chat. This may cause the users to feel dissatisfied.

The present invention has been conceived in view of the above, and an object thereof is to provide a network game system, a network game system control method, a game control device, and an information storage medium capable of, in a network game system which carries out a game in which a plurality of first game characters operated by a plurality of users and one or more second game characters act, reflecting the content of a chat among the plurality of users in an action or actions of the one or more second game characters.

In order to solve the above described problem, according to one aspect of the present invention, there is provided a network game system including a plurality of game devices, for carrying out a game in which a plurality of first game characters which are a plurality of operation targets for a plurality of users and one or more second game characters act, wherein each of the plurality of game devices comprises an input accepting section for accepting input of a chat message addressed to one or more users of one or more other game devices; a transmission section for sending information relating to the chat message input; a receiving section for receiving information relating to a chat message input in another game device; and an output control section, in a case where the information relating to the chat message input in the other game device is received, for outputting the chat message, the network game system comprises a first game character control section for controlling action of a first game character which is an operation target for a user, based on an operation carried out by the user; an action control data storage section for storing action control data for use as a basis for action control by the one or more second game characters; a second game character control section for controlling action of the one or more second game characters, based on the action control data; and an action control data changing section, in a case where a chat message addressed to one or more users of one or more other game devices is input in any game device, for changing the action control data, based on the chat message.

According to another aspect of the present invention, there is provided a control method for a network game system for carrying out a game in which a plurality of first game characters operated by a plurality of users and one or more second game characters act, comprising: a first game character control step of controlling action of a first game character operated by a user, based on an operation carried out by the user; a step of obtaining from an action control data storage section, for storing action control data for use as a basis for action control of the one or more second game characters, the action control data; a second game character control step of controlling action of the one or more second game characters, based on the action control data; and an action control data changing step, in a case where any user of the plurality of users inputs a chat message addressed to one or more other users of the plurality of users, of changing the action control data, based on the chat message.

According to another aspect of the present invention, there is provided a game control device for controlling a game in which a plurality of first game characters operated by a plurality of users and one or more second game characters act, comprising a first game character control section for controlling action of a first game character operated by a user, based on an operation carried out by the user; a section for obtaining from an action control data storage section, for storing action control data for use as a basios for action control of the one or more second game characters, the action control data; a second game character control section for controlling action of the one or more second game characters, based on the action control data; and an action control data changing section, in a case where any user of the plurality of users inputs a chat message addressed to one or more other users of the plurality of users, for changing the action control data, based on the chat message.

According to another aspect of the present invention, there is provided a program for causing a computer, such as a consumer game device, a portable game device, a portable telephone, a personal digital assistant (PDA), a personal computer, a server computer, or the like, to function as a game control device for controlling a game in which a plurality of first game characters operated by a plurality of users and one or more second game characters act, the program for causing the computer to function as a first game character control section for controlling action of the first game character operated by a user, based on an operation carried out by the user; a section for obtaining from an action control data storage section for storing action control data for use as a base of action control of the one or more second game characters, the action control data; a second game character control section for controlling action of the one or more second game characters, based on the action control data; and an action control data changing section, in a case where any user of the plurality of users inputs a chat message addressed to one or more other users of the plurality of users, for changing the action control data, based on the chat message.

An information storage medium according to the present invention is a computer readable information storage medium storing the above described program.

According to the present invention, in a network game system for carrying out a game in which a plurality of first game characters which are operation targets for a plurality of users and one or more second game characters act, it is possible to reflect the content of a chat among the plurality of users in an action or actions of the one or more second game characters.

In one embodiment of the present invention, the action control data changing section may include a section for changing the action control data, based on a number of users having input the same or similar chat messages, and the same or similar chat messages themselves.

In one embodiment of the present invention, the action control data changing section may include a section for changing, in a case where a chat message is input in any game device, the action control data for use as a basis for action control of the second game character, based on the chat message and a distance between a first game character, which is an operation target for a user having input the chat message, and the second game character.

In one embodiment of the present invention, the action control data changing section may include a section for restricting change to the action control data for use as a base of the action control of the second game character in a case where the distance is longer than a reference distance, and a section for controlling the reference distance, based on a parameter of at least one of the first game character, which is the operation target for the user having input the chat message, and the second game character.

In one embodiment of the present invention, the action control data changing section may include a section for changing, in a case where a chat message is input in any game device, the action control data for use as a base of action control of the second game character, based on the chat message and a parameter of at least one of a first game character which is an operation target for a user having input the chat message and the second game character.

In one embodiment of the present invention, the input accepting section may display a selection screen image for selecting at least one of a plurality of chat messages as the chat message addressed to the one or more users of the one or more other game devices. The transmission section may send information relating to the chat message selected. The receiving section may receive information relating to a chat message selected in another game device. The input accepting section may include a section for displaying, in a case where the information relating to the chat message selected in the other game device is received, distinctly or with priority, the chat message or a chat message having a predetermined relationship with the chat message in the selection screen image.

In one embodiment of the present invention, the input accepting section may display a selection screen image for selecting at least one of a plurality of chat messages as the chat message addressed to the one or more users of the one or more other game devices. The transmission section may send information relating to the chat message selected. The receiving section may receive information relating to a chat message selected in another game device. The input accepting section may include a section for, in a case where the information relating to the chat message selected in the other game device is received, replacing the chat message or a chat message having a predetermined relationship to the chat message, with a predetermined chat message in the selection screen image.

In one embodiment of the present invention, the network game system may further comprise a section for evaluating an action of the plurality of second game characters after the action control data is changed based on the chat message input in the game device, to thereby evaluate a user having input the chat message. The action control data changing section may include a section for, in a case where another chat message is input in any game device, changing the action control data, based on the chat message and an evaluation result on the user having input the chat message.

In one embodiment of the present invention, the network game system may further comprise a section for evaluating an action of the plurality of second game characters after the action control data is changed based on the chat message input in the game device, to thereby evaluate a user having input the chat message. The output control section may include a section for, in a case where information relating to another chat message input in another game device is received, outputting the chat message, based on an evaluation result on the user having input the chat message.

In one embodiment of the present invention, the network game system may further comprise a section for switching the operation target for the user to any of the one or more second game characters; and a section for, after the action control data is changed based on the chat message input in the game device, restricting switching of the operation target for the user to a second game character engaged in an action corresponding to the chat message.

### BRIEF DESCRIPTION OF THE DRAWINGS

FIG. 1 is a diagram showing an overall structure of a network game system according to this embodiment;

FIG. 2 is a diagram showing a hardware structure of a game management device;

FIG. 3 is a diagram showing a hardware structure of a game device;

FIG. 4 is a diagram showing one example of a game space;

FIG. 5 is a diagram showing one example of a process for communizing the game space;

FIG. 6 is a diagram showing one example of a game screen image;

FIG. 7 is a diagram explaining a chat function;

FIG. 8 is a diagram explaining the chat function;

FIG. 9 is a functional block diagram of the network game system according to the embodiment;

FIG. 10 is a diagram showing one example of action control data;

FIG. 11 is a diagram showing one example of a chat message table;

FIG. 12 is a diagram showing one example of data for changing action control data;

FIG. 13 is a flowchart of one example of a process carried out in the network game system;

FIG. 14 is a diagram showing one example of data for changing action control data; and

FIG. 15 is a diagram showing one example of data for changing action control data.

### DETAILED DESCRIPTION OF THE INVENTION

In the following, one example of an embodiment of the present invention will be described in detail with reference to the accompanying drawings.

### [Structure]

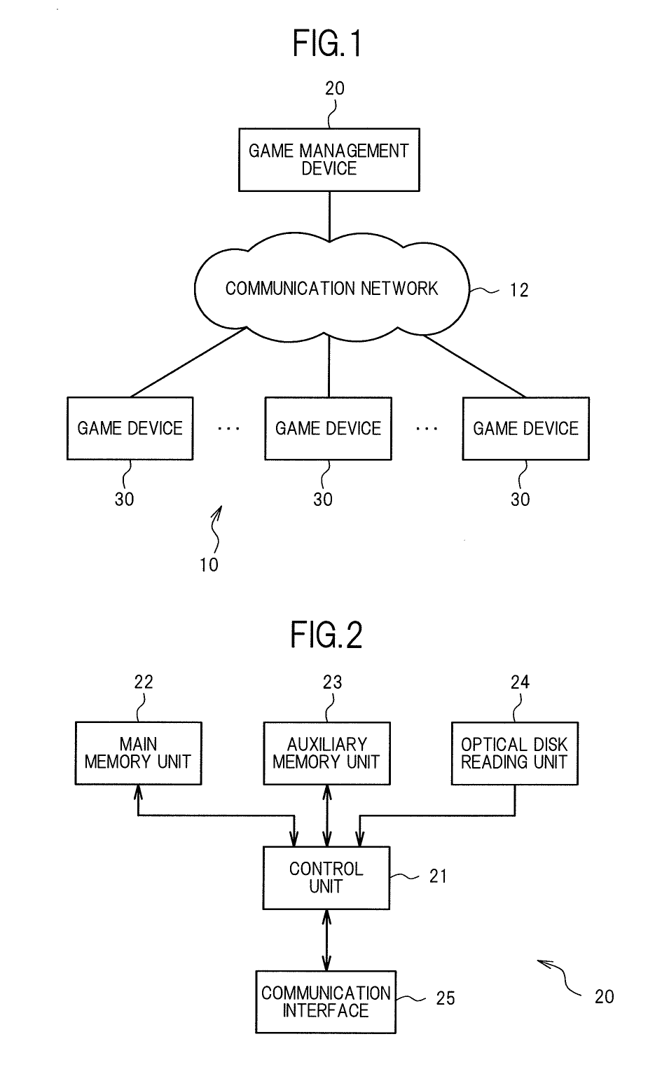

FIG. 1 is a diagram showing a complete structure of a network game system according to an embodiment of the present invention. As shown in FIG. 1, a network game system 10 according to the embodiment comprises a game management device 20 and a plurality of game devices 30. The game management device 20 and the plurality of game devices 30 are connected to a communication network 12 including, e.g., a LAN (Local Area Network), the Internet, or the like. Data transmission is possible between the game management device 20 and any game device 30, as well as between one game device 30 and another game device 30.

The game management device 20 is realized using a publicly known server computer. The game management device 20 manages information (e.g., IP address or the like) of the respective game devices 30, and provides each of the game devices 30 with information about the other game devices 30.

FIG. 2 is a diagram showing a hardware structure of the game management device 20. As shown in FIG. 2, the game management device 20 comprises a control unit 21, a main memory unit 22, an auxiliary memory unit 23, an optical disk reading unit 24, and a communication interface 25.

The control unit 21 is e.g., a CPU (Central Processing Unit) and carries out various information processes according to an operating system and other programs. The main memory unit 22 comprises, e.g., a RAM (Random Access Memory), and a program and data read from the auxiliary memory unit 23 or the optical disk (an information storage medium) are stored in the main memory unit 22. The main memory unit 22 is used also as a working memory for storing data necessary in the processes.

The auxiliary memory unit 23 comprises, e.g., a hard disk device. An optical disk is mounted in the optical disk reading unit 24, which then reads a program and data recorded on the optical disk. The communication interface 25 is an interface for connecting the game management device 20 to the communication network 12.

The game device 30 is a device for a user to play a game, and is realized using, e.g., a consumer game device (an installation type game device), a portable game device, a portable phone, a personal digital assistant (PDA), or a personal computer. In this specification, a case in which the game device 30 is realized using a consumer game device will be described.

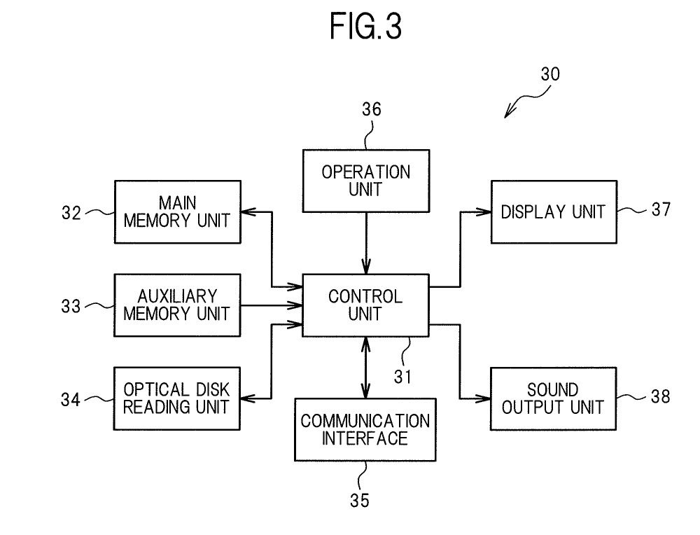

FIG. 3 is a diagram showing a hardware structure of a game device 30. As shown in FIG. 3, the game device 30 comprises a control unit 31, a main memory unit 32, an auxiliary memory unit 33, an optical disk reading unit 34, a communication interface 35, an operation unit 36, a display unit 37, and a sound output unit 38.

The control unit 31 comprises, e.g., a CPU, a GPU (Graphics Processing Unit), an SPU (Sound Processing Unit), and so forth, and carries out various information processes according to an operation system and other programs. The main memory unit 32 comprises, e.g., a RAM, and a program and data read from the auxiliary memory unit 33 or the optical disk are stored in the main memory unit 32. The main memory unit 32 is used also as a working memory for storing data necessary in the processes.

The auxiliary memory unit 33 comprises, e.g., a hard disk device (an information storage medium) or a memory card slot where a memory card (an information storage medium) is mounted. An optical disk is mounted in the optical disk reading unit 34, which reads a program and data recorded on the optical disk.

The communication interface 35 is an interface for connecting the game device 30 to the communication network 12 for communication. The operation unit 36 comprises, e.g., a controller, a touch panel, or the like, and receives an operation carried out by a user. The display unit 37 is, e.g., a home-use television set receiver, a liquid crystal display panel, or the like, and shows a screen image according to an instruction from the control unit 31. The sound output unit 38 includes, e.g., a speaker, a headphone, or the like, and outputs various sound data such as game music, game sound effects, a message, or the like, read from the auxiliary memory unit 33 or the optical disk, according to an instruction from the control unit 31.

Note that, e.g., a program and data are supplied via an optical disk to the game management device 20 or a game device 30. Alternatively, a program and data may be supplied from a remote place to the game management device 20 or a game device 30 via the communication network 12.

### [Game]

In the network game system 10, a game in which a game character group to which a plurality of game characters belong is cooperatively operated by a plurality of users in separate places is carried out. In the following, a case in which a soccer game between a soccer team cooperatively operated by three users, namely, users A, B, and C, (hereinafter referred to as “the user team”) and an opponent team is carried out in the network game system 10 will be described.

### [Game Space, Game Screen Image]

In order to realize such a soccer game, a common game space is created in the respective main memory units 32 of the game device 30 of the user A (hereinafter referred to as the “game device A”), of the game device 30 of the user B (hereinafter referred to as the “game device B”), and of the game device 30 of the user C (hereinafter referred to as the “game device C”).

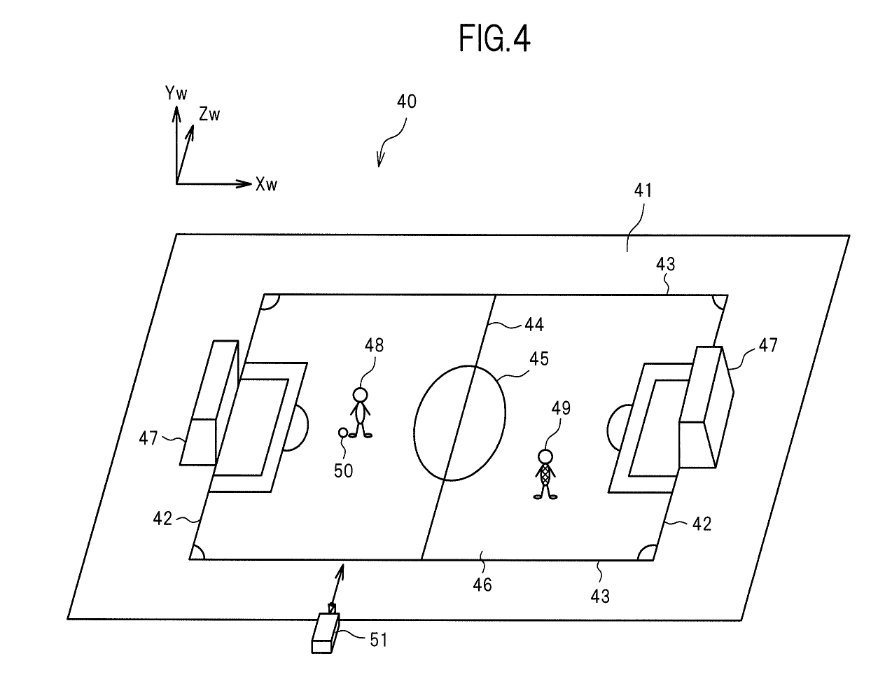

FIG. 4 is a diagram showing one example of the common game space. The game space 40 shown in FIG. 4 is a virtual three dimensional space. As shown in FIG. 4, a field 41, or an object representing a soccer field, is placed in the game space 40. In addition, goal lines 42, touch lines 43, a halfway line 44, a center circle 45, and so forth are also shown on the field 41. A pitch 46 is an area enclosed by two goal lines 42 and two touch lines 43.

In addition, a goal 47, or an object representing a goal, a player character 48, or an object representing a soccer player belonging to the user team, a player character 49, or an object representing a soccer player belonging to the opponent team, a ball 50, or an object representing the soccer ball, are placed on the field 41. Although not shown in FIG. 4, eleven player characters 48 belonging to the user team and eleven player characters 49 belonging to the opponent team are placed in the game space 40.

The user team includes a player character 48 which is an operation target of the user A (hereinafter referred to as a “user character A”), a player character 48 which is an operation target of the user B (hereinafter referred to as a “user character B”), a player character 48 which is an operation target of the user C (hereinafter referred to as a “user character C”), and a player character 48 which is not an operation target of any user (hereinafter referred to as a “teammate character”).

The user character A acts according to an operation carried out by the user A. Similarly, the user character B acts according to an operation carried out by the user B, and the user character C acts according to an operation carried out by the user C. A teammate character acts according to an operation carried out by the computer (CPU), in other words, according to artificial intelligence, or AI.

Note that an operation target of the user A (the user character A) is switched among the player characters 48 belonging to the user team. For example, when the user A presses a predetermined switch button on the controller (the operation unit 36), any teammate character is set to a new operation target of the user A, and the player character 48 which has been the operation target of the user A so far becomes a teammate character. Similarly, the respective operation targets of the users B and C are also switched among the player characters 48 belonging to the user team.

The goal 47 is correlated to either team. With the ball 50 having been moved into inside the goal 47 correlated to one team, a goal event occurs to the other team.

In the following, one example of a method for communizing the game space 40 among the game devices A to C will be described. In this embodiment, any of the game devices A to C serves as a game server (a game control device) so that the game space 40 is communized among the game devices A to C. In this specification, a case in which the game device A serves as the game server will be described. In this case, game situation data describing the latest game situation is stored in the main memory unit 32 of the game device A, with copies of the game situation data being stored in the respective main memory units 32 of the game devices B and C.

The game situation data comprises data describing the current situation of the game space 40 and data describing progress of a match. For example, the data describing the current situation of the game space 40 includes the data mentioned below:

(a) data describing the state (e.g., position, posture, moving speed, and so forth) of the player characters 48, 49;
(b) data describing the state (e.g., position, moving speed, and so forth) of the ball 50;
(c) data identifying the player character 48, 49 in possession of the ball 50; and
(d) data identifying the respective player characters 48 which are operation targets for the users A to C.

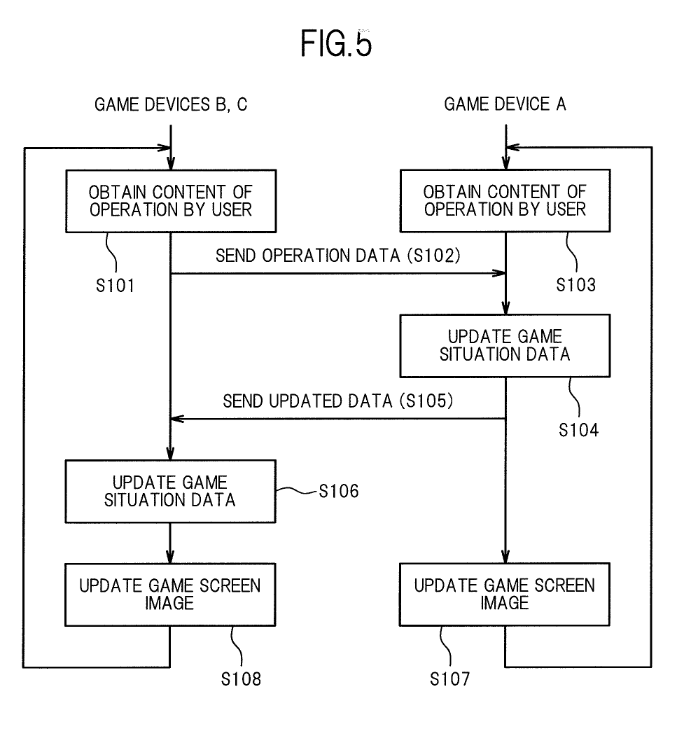

FIG. 5 is a diagram showing one example of a process to be carried out to communize the game space 40 among the game devices A to C. The process shown in FIG. 5 is repetitively carried out during a match.

As shown in FIG. 5, supposing that the game device A serves as the game server, the game device B obtains the content of an operation carried out by the user B (S101), and sends operation data relating to the operation carried out by the user B to the game device A (S102). Similarly, the game device C obtains the content of an operation carried out by the user C (S101), and sends operation data relating to the operation carried out by the user C to the game device A (S102).

Meanwhile, the game device A obtains operation data relating to an operation carried out by the user A (S103), and updates the game situation data stored in the game device A, based on the operation data (an operation carried out by the user A) obtained at S103 and the operation data (operations carried out by the respective users B and C) received from the respective game devices B and C (S104).

Thereafter, the game device A sends update data to the game devices B and C to inform the game devices B and C of the updated content of the game situation data (S105). Then, the game device B updates the game situation data stored in the game device B, based on the update data received from the game device A (S106). Similarly, the game device C updates the game situation data stored in the game device C, based on the update data received from the game device A (S106).

Note that in the game device A, the game screen image is updated based on the game situation data stored in the game device A (S107). Similarly, in the respective game devices B and C, the game screen image is updated based on the game situation data stored in the respective game devices B and C (S108).

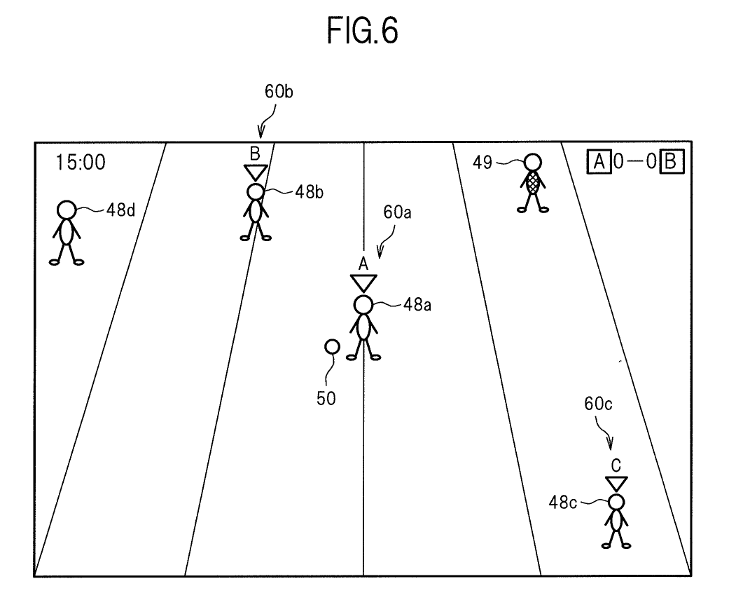

FIG. 6 shows one example of a game screen image. In the game screen image, an image showing a picture obtained by viewing the game space 40 from the virtual camera 51 is shown. Note that the virtual camera 51 is set for each user. In other words, the virtual camera 51 is set in each game device 30. For example, a screen image showing a picture obtained by viewing the game space 40 from the virtual camera 51 for the user A (the game device A) is displayed on the display unit 37 of the game device A. The virtual camera 51 for the user A moves based on the position of the user character A such that the user character A is always shown in the game screen image.

Similarly, a screen image showing a picture obtained by viewing the game space 40 from the virtual camera 51 for the user B (the game device B) is displayed on the display unit 37 of the game device B. The virtual camera 51 for the user B moves based on the position of the user character B such that the user character B is always shown in the game screen image. A screen image showing a picture obtained by viewing the game space 40 from the virtual camera 51 for the user C (game device C) is displayed on the display unit 37 of the game device C. The virtual camera 51 for the user C moves based on the position of the user character C such that the user character C is always shown in the game screen image.

In the game screen image shown in FIG. 6, a user character A 48a, a user character B 48b, a user character C 48c, a teammate character 48d, and a player character 49 belonging to the opponent team are shown. Further, cursors 60a, 60b, 60c are also shown in the game screen image. The cursor 60a identifies a player character 48 operated by the user A (that is, the user character A 48a). Similarly, the cursor 60b identifies a player character 48 operated by the user B (that is, the user character B 48b), and the cursor 60c identifies a player character 48 operated by the user C (that is, the user character C 48c).

### [Chat Function]

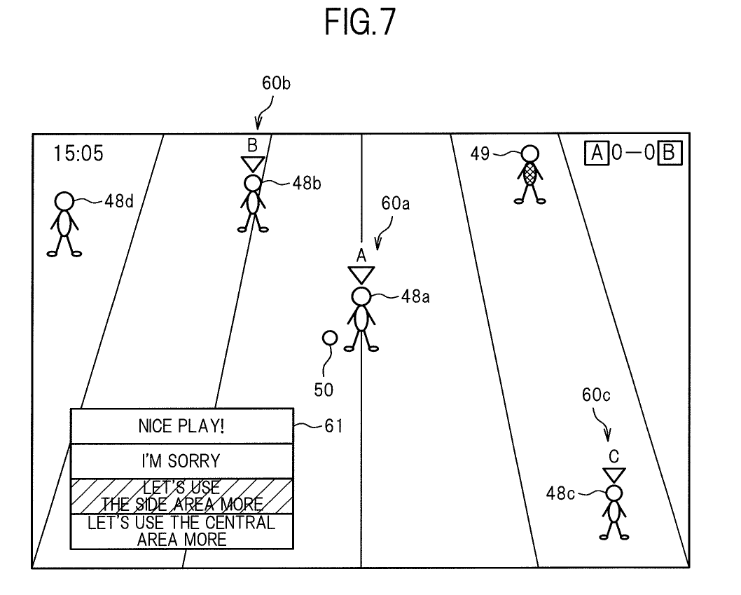

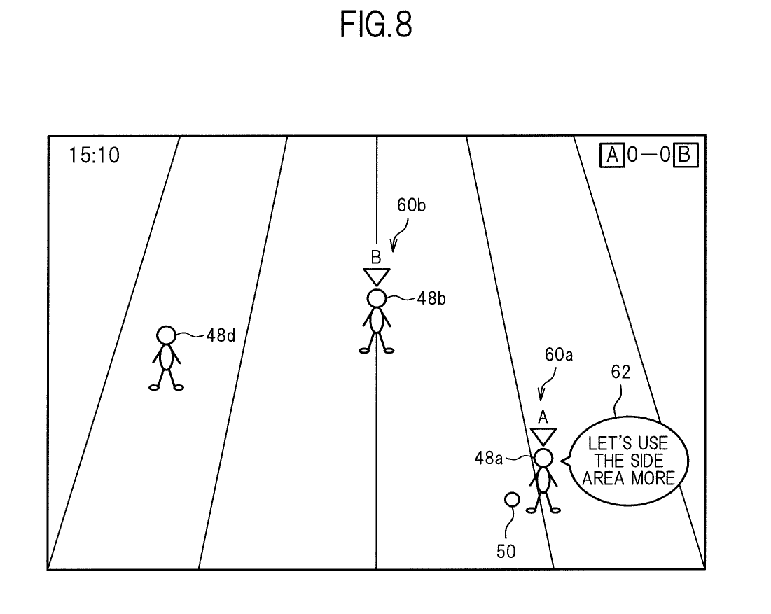

The network game system 10 has a chat function. That is, a user can send a chat message to another user. FIGS. 7 and 8 are diagrams explaining the chat function.

In the network game system 10, e.g., if a user presses a predetermined button on the controller (the operation unit 36), a menu 61 for chat message selection is shown in the game screen image, as shown in FIG. 7. In the menu 61 shown in FIG. 7, four chat messages, namely, “Nice play!”, “I'm sorry”, “Let's use the side area more”, and “Let's use the central area more”, are shown as candidates for a chat message to be sent to another user.

The chat message “Let's use the side area more” is used to suggest to another user main use of an area in the pitch 46 near the touch line 43 to attack, while the chat message “Let's use the central area more” is used to suggest to another user main use of the central area in the pitch 46 to attack.

In selection of a chat message to be sent to one or more users of one or more other game devices 30, initially, a user carries out a designation operation, using the controller (the operation unit 36) to thereby place their desired chat message in a designated state. In the example shown in FIG. 7, the chat message “Let's use the side area more” is distinctly displayed. This means that the chat message “Let's use the side area more” is in a designated state. Then, the user carries out a deciding operation, using the controller (the operation unit 36), to decide (select) the chat message in the designated state as a chat message to be sent to another user. In this manner, the user carries out the above described designation operation and deciding operation to select a chat message to be sent to another user.

If the user selected a chat message to another user, the selected chat message is informed to the other user. For example, with the chat message “Let's use the side area more” selected by the user A, the chat message selected by the user A is shown, e.g., as a line spoken by the user character A in the respective game screen images shown in the respective game devices B and C, as shown in FIG. 8. That is, the chat message selected by the user A is shown in the balloon 62 shown correlated to the user character A. In this manner, the users B and C can know the content of the chat (the content of the chat message) by the user A. Thereafter, the users A to C operate the respective user characters A to C so that an attack can be cooperatively carried out along the line of the content of the chat by the user A.

### [Functional Block]

In the following, a technique for reflecting the content of a chat among the users A to C in an action of a teammate character in the network game system 10 will be described.

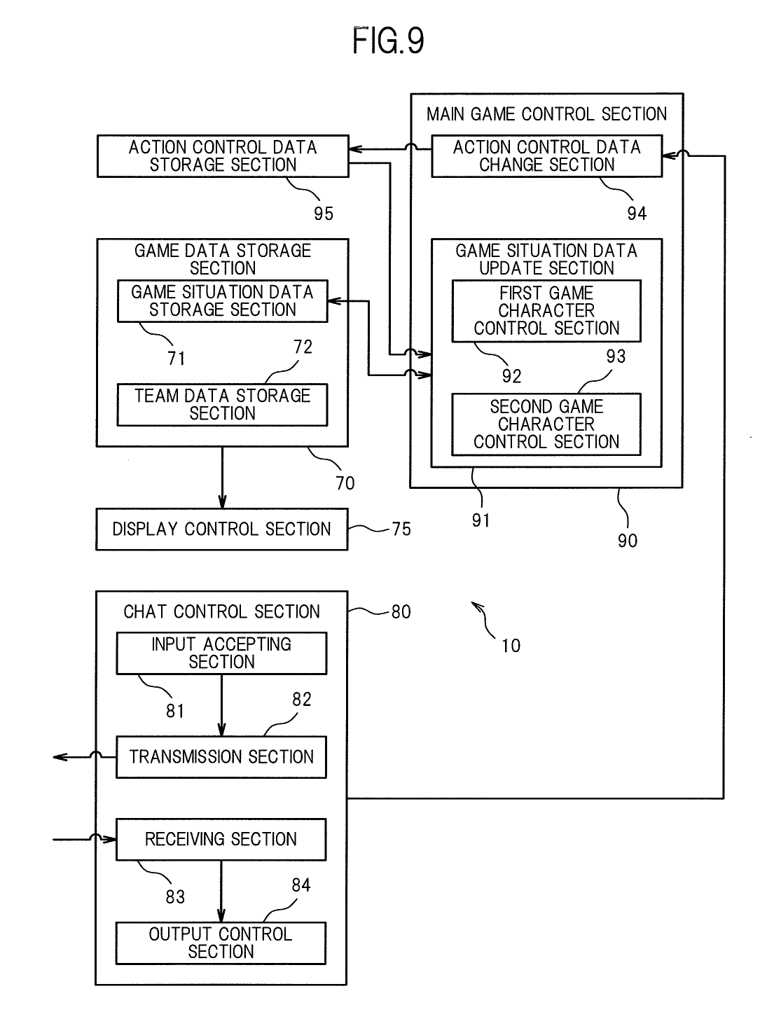

FIG. 9 is a functional block diagram showing functions realized in the network game system 10. As shown in FIG. 9, the network game system 10 comprises a game data storage section 70, a display control section 75, a chat control section 80, a main game control section 90, and an action control data storage section 95. For example, the game data storage section 70, the display control section 75, and the chat control section 80 are provided to each of the game devices A, B, C, and the main game control section 90 and the action control data storage section 95 are provided to a game device 30 serving as the game server (a game control device).

The game data storage section 70 is realized mainly using, e.g., the main memory unit 32, the auxiliary memory unit 33, and an optical disk mounted in the optical disk reading unit 34. The game data storage section 70 stores data necessary to carry out a game.

For example, the game data storage section 70 comprises a game situation data storage section 71 and a team data storage section 72. The game situation data storage section 71 stores the above-described game situation data.

The team data storage section 72 stores data on the user team and the opponent team. For example, the team data storage section 72 stores a parameter (e.g., an ability parameter or the like) of a player character 48 belonging to the user team and that of a player character 49 belonging to the opponent team.

The action control data storage section 95 is realized using, e.g., the main memory unit 32 or the auxiliary memory unit 33. The action control data storage section 95 stores action control data for use as a basis for action control of a teammate character (a second game character). The action control data includes, e.g., formation data, strategy data, and so forth of the user team.

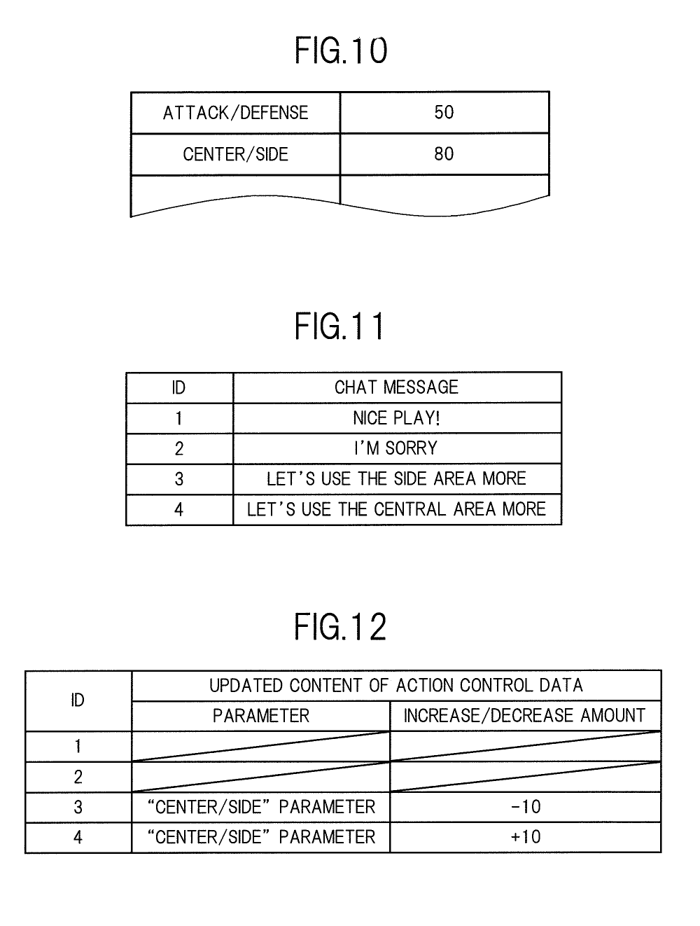

FIG. 10 is a diagram showing one example of the action control data. The action control data shown in FIG. 10 includes an “attack/defense” parameter and a “center/side” parameter. The “attack/defense” parameter and the “center/side” parameter are set by the representative of the users A to C, e.g., before a match starts or at half time. The “center/side” parameter is changed by the action control data change section 94 to be described later.

The “attack/defense” parameter is a parameter indicating which of attack and defense is to be given more emphasis. For example, the “attack/defense” parameter takes a value from 0 to 100, and a larger value of the “attack/defense” parameter means to give more importance to attack. In other words, a smaller value of the “attack/defense” parameter means to give more importance to defense.

The “center/side” parameter is a parameter indicating which of the central area of the pitch 46 and an area near the touch line 43 is to be mainly utilized in attack. For example, the “center/side” parameter” parameter also takes a value from 0 to 100, and a larger value of the “center/side” parameter means to utilize the central area of the pitch 46 more. In other words, a smaller value of the “center/side” parameter means to utilize an area near the touch line 43 more in attack.

The display control section 75 causes the display unit 37 to display a game screen image showing a picture obtained by viewing the game space 40 from the virtual camera 51, based on the data stored in the game data storage section 70.

The main game control section 90 carries out a process (a main game process) for advancing a match of a soccer game. The main game control section 90 is realized by the control unit 31 by executing the program.

The main game control section 90 includes a game situation data update section 91. The game situation data update section 91 updates the game situation data stored in the respective game situation data storage units 71 of the game devices A to C.

For example, if the game device A serves as the game server, the game situation data update section 91 updates the game situation data stored in the game situation data storage section 71 of the game device A, based on respective operations carried out by the users A to C in the respective game devices A to C (see S104 in FIG. 5). Thereafter, the game situation data update section 91 sends update data describing the updated content to the game devices B and C so that the game situation data stored in the respective game situation data storage units 71 of the game devices B and C (see S105, S106 in FIG. 5) is updated.

The game situation data update section 91 comprises a first game character control section 92 and a second game character control section 93.

The first game character control section 92 controls the action of a user character (a first game character) operated by a user, based on an operation carried out by the user. For example, the state (e.g., position, posture, and so forth) of the user character A is controlled based on an operation carried out by the user A in the game device A. Similarly, the state of the user character B is controlled based on an operation carried out by the user B in the game device B. The state of the user character C is controlled based on an operation carried out by the user C in the game device C.

The second game character control section 93 controls the action of a teammate character (a second game character), based on the action control data stored in the action control data storage section 95. For example, if the “attack/defense” parameter value is larger than 50, an action of a teammate character is controlled so as to put more emphasis on attack than defense. Meanwhile, if the “attack/defense” parameter value is smaller than 50, an action of a teammate character is controlled so as to put more emphasis on defense than attack.

Similarly, if the “center/side” parameter value is larger than 50, an action of a teammate character is controlled so as to mainly utilize the central area of the pitch 46. Meanwhile, if the “center/side” parameter value is smaller than 50, an action of a teammate character is controlled so as to mainly utilize an area near the touch line 43.

Note that although not shown in FIG. 9, the game situation data update section 91 additionally comprises a functional block for controlling the action of a player character 49 belonging to the opponent team and a functional block for controlling the movement of the ball 50. In addition, the game situation data update section 91 has a functional block for switching an operation target of a user, based on a switching operation carried out by the user.

The main game control section 90 has an action control data change section 94, details of which are to be described later.

The chat control section 80 is a functional block relating to the chat function. The chat control section 80 is realized by the control unit 31 executing the program. The chat control section 80 comprises an input accepting section 81, a transmission section 82, a receiving section 83, and an output control section 84.

The input accepting section 81 accepts input of a chat message addressed to one or more users of one or more other game devices 30, and the transmission section 82 sends information relating to the chat message input. Note that “information relating to a chat message” may be the chat message itself or ID information of the chat message.

In this embodiment, a candidate for a chat message is stored in the game data storage section 70. FIG. 11 shows one example of a chat message table stored in the game data storage section 70. The chat message table shown in FIG. 11 is data describing a list of chat messages available for user selection. Note that “ID” in FIG. 11 is ID information uniquely identifying a chat message.

The input accepting section 81 obtains the chat message table stored in the game data storage section 70, and based on the obtained chat message table, displays, e.g., the menu 61, such as is shown in FIG. 7, in the game screen image. The transmission section 82 sends the ID of a chat message selected by a user to one or more other game devices 30.

Specifically, the input accepting section 81 may receive a chat message which is input using a keyboard or a software keyboard or sound input of a chat message. The transmission section 82 may send the chat message input itself to one or more other game devices 30.

The receiving section 83 receives information relating to a chat message input in another game device 30. If information relating to a chat message input in another game device 30 is received, the output control section 84 outputs the chat message. Note that “to output” includes to display the chat message and to output a sound informing that there is a chat message.

In this embodiment, the output control section 84 shows a chat message input in another game device 30 in the game screen image, as shown in, e.g., FIG. 8. In this case, the output control section 84 can be regarded as a part of the display control section 75.

In the following, the action control data change section 94 will be described in detail. If a chat message is input in one game device 30, addressed to one or more users of one or more other game devices 30, the action control data change section 94 changes the action control data stored in the action control data storage section 95, based on the chat message.

As described above, in this embodiment, the action control data change section 94 is realized in a game device 30 carrying out the function of a game server. For example, if a chat message is input in the game device 30 carrying out the function of a game server, the action control data change section 94 changes the action control data, based on the chat message input. Meanwhile, if a chat message input in a game device 30 not carrying out the function of a game server is received by the game device 30 carrying out the function of a game server, the action control data change section 94 changes the action control data, based on the chat message received.

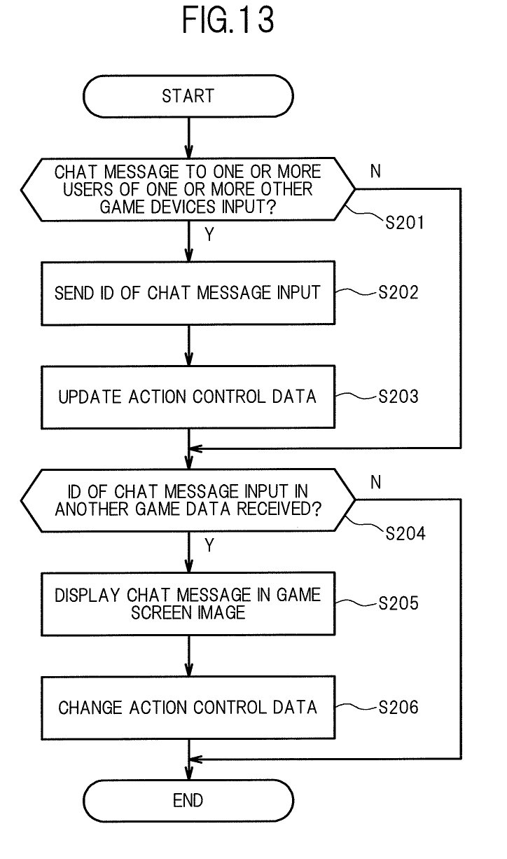

In this embodiment, data for changing the action control data based on a chat message is stored in the game data storage section 70. FIG. 12 shows one example of such data for changing the action control data based on a chat message. The data correlates a chat message and information relating to the content of change to be made to the action control data. In the example shown in FIG. 12, the ID of a chat message is correlated to the content of change to be made to the action control data (a parameter to be changed and an increase/decrease amount). Based on the data shown in FIG. 12, the action control data change section 94 changes the action control data, with details thereof being described later (see S203, S206 in FIG. 13).

### [Process]

A process to be carried out in the network game system 10 will be described. FIG. 13 is a flowchart of one example of a process to be carried out in the network game system 10. The process shown in FIG. 13 is a part of a process to be carried out during a match every predetermined period of time (e.g., 1/60^{th} of a second) in the game device 30 serving as the game server. The process shown in FIG. 13 is carried out in parallel to the process shown in FIG. 5. The control unit 31 carries out the process shown in FIG. 13 according to the program.

As shown in FIG. 13, the control unit 31 (the input accepting section 81) determines whether or not a chat message has been input in the game device 30 serving as the game server, which is addressed to one or more users of one or more other game devices 30 (S201). Specifically, based on an operation signal supplied from the operation unit 36, the control unit 31 determines whether or not a deciding operation has been carried out, with any of the chat messages on the menu 61 for chat message input being in a designated state.

If it is determined that a chat message to one or more users of one or more other game devices 30 has been input, the control unit 31 (the transmission section 82) sends the ID of the chat message input to that game device 30 (that is, a game device 30 not serving as the game server) (S202).

Moreover, the control unit 31 (the action control data change section 94) changes the action control data, based on the chat message input (S203). Specifically, referring to the data shown in FIG. 12, the control unit 31 obtains the content of change to be made the action control data, which accords with the chat message input, and then changes the action control data. For example, with the chat message, e.g., “Let's use the side area more” input, the control unit 31 reduces the value of the “center/side” parameter by 10, and with the chat message, e.g., “Let's use the central area more” input, the control unit 31 increases the value of the “center/side” parameter by 10.

If the process at S203 is carried out or if it is determined at S201 that no chat message has been input, the control unit 31 (the receiving section 83) then determines whether or not the ID of a chat message input in another game device 30 (that is, a game device 30 not serving as the game server) has been received (S204).

In a game device 30 not serving as the game server as well, a process similar to that at S201 and S202 is carried out. That is, whether or not a chat message has been input is determined, and with a chat message input, the ID of the chat message is sent to one or more other game devices 30. At S204, whether or not the ID of a chat message sent from a game device 30 not serving as the game server has been received is determined.

If it is determined that the ID of a chat message input in another game device 30 has been received, the control unit 31 (the output control section 84) shows the chat message in the game screen image, based on the received chat message ID (S205).

In addition, the control unit 31 (the action control data change section 94) changes the action control data, based on the received chat message ID (S206). The process at S206 is carried out similarly to the process at S203.

### [Effects]

In the above described network game system 10, if a chat message is input in one game device 30, addressed to one or more users of one or more other game devices 30, the action control data for use as a basis for action control of a teammate character is changed based on the chat message input. As a result, the content of the chat among the users A to C is reflected in an action of the teammate character.

Note that as a method for reflecting the content of a chat among the users A to C in an action of a teammate character, there is available a method in which the representative of the users A to C changes the action control data in consideration of the content of the chat among the users A to C. This method, however, imposes a burden on the representative of the users A to C. Regarding this point, according to the network game system 10, the users A to C are imposed with only a slight burden.

### MODIFIED EXAMPLES

Note that the present invention is not limited to the above described embodiments.

(1) For example, a chat message “Let's focus on attack” or “Let's focus on defense” may be input as a chat message to one or more users of one or more other game devices 30. With such a chat message input, the “attack/defense” parameter may be changed.

(2) For example, although it is described in the above that any of the game devices A to C serves as the game server, a separate server computer from the game devices A to C may serve as the game server. A hardware structure of the server computer is identical to that of the game management device 20 (see FIG. 2).

In this modified example (2), the game space is communized among the game devices A to C in the manner to be described below. That is, in the modified example (2), game situation data describing the latest game situation is stored in the auxiliary memory unit 23 of the server computer, and a copy of the game situation data is stored in the respective main memory units 32 of the game devices A to C.

In the modified example (2), the game devices A to C respectively send operation data to the server computer. The server computer updates the game situation data stored in the server computer, based on the operation data received from the respective game devices A to C. Then, the server computer sends update data describing the updated content of the game situation data to the game devices A to C. Based on the update data received from the server computer, the game device A updates the game situation data stored in the game device A, and further, based on the updated game situation data, displays a game screen image on the display unit 37 of the game device A. This is similarly applied to the game devices B and C.

In the modified example (2), a chat message input in one game device 30 may be sent via the server computer to one or more other game devices 30. That is, the transmission section 82 may send information relating to the chat message input to the server computer. The server computer may send information relating to the chat message received from the game device 30 to one or more other game devices 30. The receiving section 83 may receive the information relating to the chat message from the server computer.

It should be noted that in the modified example (2), the game data storage section 70 is realized in the server computer and the respective game devices A to C. The display control section 75 and the chat control section 80 are realized in the respective game devices A to C. The main game control section 90 and the action control data storage section 95 are realized in the server computer (the game control device).

(3) For example, the game devices A to C may mutually exchange operation data. In this case, none of the game devices A to C needs to serve as the game server, and there is no need to prepare a server computer serving as the game server.

In the modified example (3), the game space is communized among the game devices A to C in the manner to be described below. That is, in the modified example (3), game situation data describing the latest game situation is stored in the respective main memory units 32 of the game devices A to C, and the game device A sends operation data relating to an operation carried out in the game device A to the game devices B and C. Similarly, the game device B sends operation data relating to an operation carried out in the game device B to the game devices A and C, and the game device C sends operation data relating to an operation carried out in the game device C to the game devices A and B.

Thereafter, the game device A updates the game situation data stored in the game device A, based on the operation data relating to an operation carried out in the game device A and the operation data received from the game devices B and C, and also displays a game screen image on the display unit 37 of the game device A, based on the updated game situation data. This is similarly applied to the game devices B and C.

In the modified example (3), the game data storage section 70, the display control section 75, and the chat control section 80 are realized in the respective game devices A to C. The main game control section 90 and the action control data storage section 95 are also realized in the respective game devices A to C (the game control device).

(4) For example, the action control data may be changed based on the number of users having input the same or similar chat messages. That is, the action control data change section 94 may change the action control data, based on the number of users having input the same or similar chat messages and the same or similar chat messages.

(4-1) More specifically, the action control data change section 94 may determine whether or not the number of users having input the same or similar chat messages satisfies a predetermined condition. With the predetermined condition satisfied, the action control data change section 94 may change the action control data, based on the same and/or similar chat messages.

For example, the action control data change section 94 may determine whether or not all of the users A to C have input the same chat messages, so that only if all of the users A to C have input the same chat messages, may the action control data change section 94 change the action control data, based on the chat message. For example, if all of the users A to C input the chat message “Let's use the side area more”, the action control data change section 94 may reduce the “center/side” parameter value according to the data shown in FIG. 12.

Note that a “predetermined condition” may be a condition as to whether or not the number of users having input the same or similar chat messages is larger than a reference number (e.g., half of all users).

In this manner, change to the action control data can be restrained, based on the number of users having input the same or similar chat messages.

(4-2) Alternatively, the action control data change section 94 may control an amount of change to be made to the action control data, based on the number of users having input the same or similar chat messages.

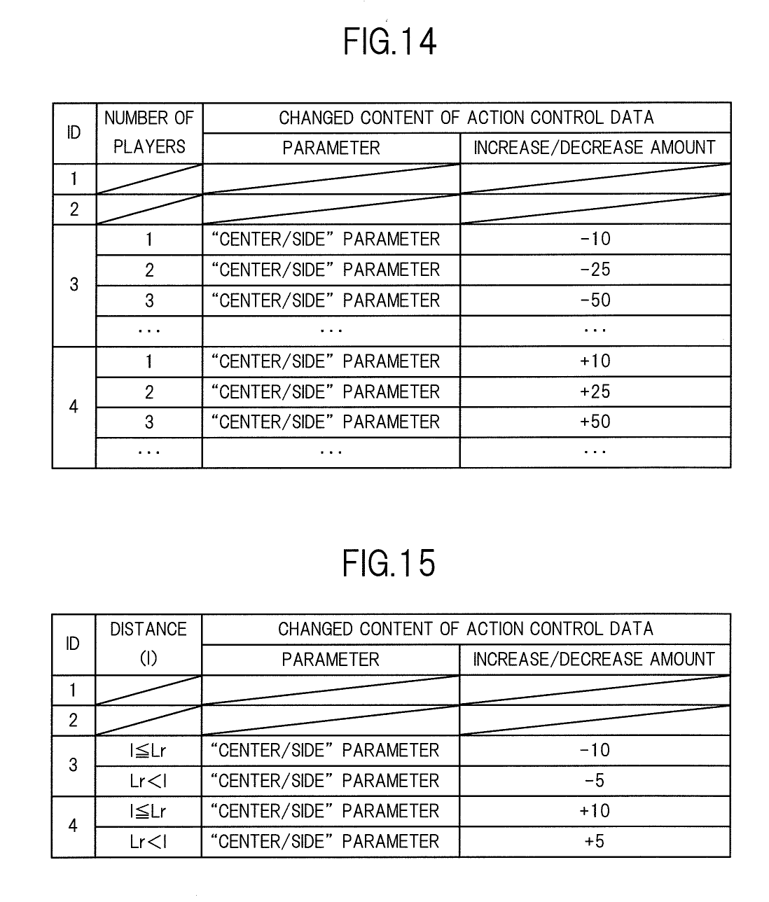

For example, in a case of changing the action control data based on a chat message input, the action control data change section 94 may control, based on the number of users having input the same chat messages, an amount of change to be made to the action control data. In this case, data for controlling an amount of change to be made to the action control data, based on the number of users having input the same chat messages, is stored in the game data storage section 70. FIG. 14 is a diagram showing one example of such data. The data shown in FIG. 14 correlates a combination of a chat message and the number of users having input the chat message to information relating to the content of change to be made to the action control data. According to the data shown in FIG. 14, a larger number of users input the chat message results in a larger amount of increase/decrease of the “center/side” parameter.

In this manner, an amount of change to be made to the action control data can be changed based on the number of users having input the same and/or similar chat messages.

(5) For example, if any user inputs a chat message, action control data for use as a basis for action control of a teammate character X may be changed, based on the distance between the player character 48 (a user character) operated by the user having input the chat message and the teammate character X.

Specifically, change to the action control data for use as a basis for action control of the teammate character X may be restricted based on whether or not the distance between the player character 48 operated by the user having input the chat message and the teammate character X is longer than a reference distance.

Note that “to restrict change to the action control data” includes, e.g., not to change the action control data at all. In addition, to set a smaller amount as an amount of change to be made to the action control data when the distance between the player character 48 operated by the user having input the chat message and the teammate character X is longer than a reference distance than when the distance is shorter than the reference distance is also included.

In the modified example (5), the action control data (the “center/side” parameter, and so forth) is stored for each of the teammate characters. If a chat message is input, e.g., by the user B in the game device B, the action control data change section 94 obtains the distance between the user character B and the teammate character X at a predetermined time. Note that a “predetermined time” refers to, e.g., a time when the user B inputs the chat message in the game device B, a time when the game device A serving as the game server receives the chat message input by the user B in the game device B, or the like.

Thereafter, the action control data change section 94 determines whether or not the distance between the user character B and the teammate character X is longer than a reference distance. If the distance between the user character B and the teammate character X is not longer than the reference distance, the action control data change section 94 changes the action control data for the teammate character X, based on the data shown in FIG. 12. Meanwhile, if the distance between the user character B and the teammate character X is longer than the reference distance, the action control data change section 94 does not change the action control data for the teammate character X.

Alternatively, the action control data change section 94 may change the action control data for the teammate character X, based on, e.g., the data shown in FIG. 15. Note that a “distance” in FIG. 15 refers to the distance from the player character 48 operated by the user having input the chat message. According to the data shown in FIG. 15, a smaller amount is set as an amount to increase/decrease the “center/side” parameter when the distance (l) from the player character 48 operated by the user having input the chat message is longer than the reference distance (Lr) than when the distance (l) is shorter than the reference distance (Lr).

According to the modified example (5), it is possible to have a user realize that, e.g., communication between the user character and a teammate character can be interrupted depending on the distance between the user character and the teammate character. Therefore, according to the modified example (5), a user is required to use the chat function in consideration of the distance between the user character and a teammate character. This resultantly enhances amusement of the chat function.

(6) For example, the reference distance (Lr) in the modified example (5) may be changed based on the ability parameter or the status parameter of the player character 48 (a user character) operated by the user having input the chat message.

For example, a larger value of the ability parameter of the player character 48 operated by the user having input the chat message may result in a longer reference distance (Lr).

For example, the reference distance (Lr) may be changed based on a tiredness parameter or a physical strength parameter of the player character 48 operated by the user having input the chat message.

The “tiredness parameter” may be a parameter whose value is increased as a player character 48 acts or time passes. It may be arranged such that a larger value of the tiredness parameter results in a shorter reference distance (Lr).

The “physical strength parameter” is a parameter whose value is decreased as a player character 48 acts or time passes. It may be arranged such that a smaller value of the physical strength parameter value results in a shorter reference distance (Lr).

Note that the reference distance (Lr) may be controlled based on the ability parameter or the status parameter of a teammate character.

According to the modified example (6), it is possible to have a user to realize that communication between the user character and a teammate character can be affected by the ability and/or status (the extent of tiredness) of the user character and/or the teammate character.

(7) For example, if any user inputs a chat message, the action control data for use as a basis for action control of the teammate character X may be changed based on a parameter (e.g., a parameter indicating the extent of comprehension of a strategy) of the player character 48 operated by the user having input the chat message (user character) or the teammate character X.

For example, it may be arranged such that, if the value of a parameter of the player character 48 operated by the user having input the chat message (or the teammate character X) is smaller than a reference value, the action control data for use as a base of action control of the teammate character X may not be changed. Alternatively, the action control data for use as a base of action control of the teammate character X may not be changed if the value of the parameter is larger than the reference value.

Also, for example, it may be arranged such that when the value of a parameter of the player character 48 operated by the user having input the chat message (or the teammate character X) is larger than a reference value, the action control data for use as a basis for action control of the teammate character X is changed by a larger amount than when the value of the parameter is smaller than the reference value. Alternatively, it may be arranged such that when the value of the parameter is smaller than the reference value, the action control data for use as a basis for action control of the teammate character X is changed by a larger amount than when the value of the parameter is larger than the reference value.

According to the modified example (7), it is possible to have a user realize that, e.g., the extent of comprehension of a strategy may be different for each player character 48.

(8) For example, if information relating to a chat message selected in another game device 30 is received, the input accepting section 81 may display distinctly or with priority the chat message or a chat message having a predetermined relationship with the chat message in a selection screen image (see FIG. 7) for selecting a chat message.

(8-1) For example, the input accepting section 81 may display distinctly or with priority a chat message selected in another game device 30 or a chat messaging having content similar to that of the chat message in the selection screen image.

For example, if a chat message “Let's use the side area more” is selected in the game device A, the input receiving units 81 of the game devices B and C may display distinctly or with priority the chat message “Let's use the side area more” in the selection screen image.

Note that “to display with priority the chat message ‘Let's use the side area more’” means to start displaying the menu 61 with the chat message “Let's use the side area more” in a distinctly displayed state. In other words, “to display with priority the chat message ‘Let's use the side area more’” means to start displaying the menu 61 with the chat message “Let's use the side area more” in a designated state.

Alternatively, for an arrangement in which a chat message to be distinctly displayed (a chat message to be placed in a designated state) is switched in a predetermined order, “to display with priority the chat message ‘Let's use the side area more’” means, e.g., to set the chat message “Let's use the side area more” first. For example, for an arrangement in which a chat message to be distinctly displayed in the menu 61 (a chat message to be placed in a designated state) is switched from top to bottom in the menu 61 in order in response to an operation carried out by a user, “to display with priority the chat message ‘Let's use the side area more’” means to display the chat message “Let's use the side area more” in the uppermost portion in the menu 61.

In this manner, it is possible to arrange such that a user can readily know or select in the selection screen image a chat message selected by another user in another game device or a chat message having content similar to that of the chat message.

(8-2) For example, the input accepting section 81 may display in the selection screen image distinctly or with priority a chat message having content contradictory to a chat message input in another game device 30.

For example, when the chat message “Let's use the side area more” is input in the game device A, the input receiving units 81 of the game devices B and C may distinctly display in the selection screen image the chat message “Let's use the central area more”, or a chat message having content contradictory to the chat message “Let's use the side area more”.

In this manner, it is possible to arrange such that a user can readily know or select in the selection screen image a chat message having content contradictory to that of a chat message selected by another user in another game device.

(9) For example, if information relating to a chat message input in another game device 30 is received, the input accepting section 81 may replace the chat message or a chat message having a predetermined relationship with the chat message by a predetermined chat message.

For example, the input accepting section 81 may replace in the selection screen image (see FIG. 7) a chat message input in another game device 30 or a chat message having content similar to that of the chat message by a chat message to the effect of agreement.

For example, when the chat message “Let's use the side area more” is selected in the game device A, the input receiving units 81 of the respective game devices B and C may replace the chat message “Let's use the side area more” by a chat message “OK!” in the selection screen image. In this case, if the chat message “OK!” is selected, it is regarded that the chat message “Let's use the side area more” is selected.

Note that the modified examples (8) and (9) may be combined. For example, in replacing the chat message “Let's use the side area more” by the chat message “OK!”, the chat message “OK!” may be displayed distinctly or with priority.

In this manner, it is possible to arrange such that a chat message selected by another user in another game device or a chat message having a predetermined relationship with the chat message can be readily selected by a user in the selection screen image.

(10) For example, it may be arranged such that when the action control data is changed based on a chat message input by a user, the user having input the chat message may be evaluated by evaluating whether or not the change results in good with the user team.

For example, if the action control data is changed based on a chat message input by the user A, the main game control section 90 may evaluate the subsequent performance of the user team to evaluate the user A.

For example, the main game control section 90 determines whether or not a predetermined game event occurs during a target period after the action control data is changed based on the chat message input by the user A. If, e.g., a goal event occurs to the user team, the evaluation value of the user A is increased. However, if, e.g., a goal event occurs to the opponent team, the evaluation value of the user A is decreased.

For example, the main game control section 90 determines whether or not a player character 48 belonging to the user team performs a type of play belonging to a certain play type in the target period. For example, if a player character 48 performs a shot that is evaluated as good, the evaluation value of the user A is increased whether the shoot goals.

Then, output control of a chat message input by the user A and/or change to the action control data in a case where the user A inputs a chat message may be effected, based on the evaluation value of the user A, obtained as described above.

That is, for example, if a chat message input by the user A is received by the game devices B and C, the respective output control units 84 of the game devices B and C may output the chat message, based on the evaluation value of the user A. Specifically, the respective output control units 84 of the game devices B and C may control an output manner for the chat message input by the user A, based on the evaluation value of the user A. Note that the “output manner” includes, e.g., a display size, an output sound volume, and so forth. For example, it may be arranged such that a higher evaluation value of the user A results in output of a chat message input by the user A in a larger size or a larger volume in the game devices B and C.

Also, for example, if the user A inputs a chat message in the game device A, the action control data change section 94 may change the action control data, based on the chat message and the evaluation value of the user A having input the chat message.

Specifically, if the user A has an evaluation value lower than a reference evaluation value, the action control data change section 94 may restrict change to the action control data based on a chat message input by the user A. Note that “to restrict change to the action control data based on a chat message input by the user A” includes, e.g., not to change the action control data, based on a chat message input by the user A. In addition, to set a smaller amount as an amount of change to be made to the action control data when the evaluation value of the user A is lower than a reference evaluation value than when the evaluation value of the user A is higher than the reference evaluation value is also included.

Alternatively, the action control data change section 94 may control an amount of change to be made to the action control data in a case where the user A inputs a chat message, based on the evaluation value of the user A. For example, it may be arranged such that a higher evaluation value of the user A results in a larger amount of change to be made to the action control data in the case where the user A inputs a chat message.

Alternatively, in changing the action control data in a case where the user A inputs a chat message, the action control data change section 94 may control the reference distance in the modified example (5), based on the evaluation value of the user A. For example, it may be arranged such that a larger evaluation value of the user A results in a longer reference distance.

In this manner, it is possible to reflect an evaluation result as to whether or not a user's inputting of a chat message has resulted in good performance by the user team, in the process of outputting a chat message and/or changing the action control data based on the chat message.

(11) For example, after the action control data is changed based on a chat message, the main game control section 90 may restrict switching of the operation target to a teammate character engaged in an action corresponding to the chat message. For example, it may be arranged to prohibit, during a target period after the action control data is changed in response to input of the chat message “Let's use the side area more”, switching of the operation target to a teammate character dashing to attack in an area near the touch line 43.

In the modified example (11), data correlating a chat message and a play type is stored in the game data storage section 70. Further, the main game control section 90 monitors, during the target period after the action control data is changed based on a chat message, whether or not a teammate character performs a type of play (action) belonging to the play type corresponding to the chat message, and restrains switching of the operation target of a user to a teammate character engaged in a type of play (action) belonging to the play type corresponding to the chat message.

That is, if the operation target of a user should be switched to a teammate character engaged in an action corresponding to the chat message, the action may be hindered even though the action corresponding to the content of the chat message is carried out. Regarding this point, according to the modified example (11), it is possible to arrange such that performance of an action corresponding to the content of a chat message is not hindered.

(12) For example, if a user does not operate the operation unit 36 at all, the first game character control section 92 may control the action of a player character 48 (user character) corresponding to the user, based on the action control data, similar to the teammate character. In this manner, it is possible to improve convenience for a user.

(13) For example, the chat message shown in the menu 61 may be changed based on the situation of the game. That is, a chat message available for user selection may be changed based on the situation of a game.

(14) For example, the game space 40 may be a two dimensional space, rather than a three dimensional space. That is, the positions of player characters 48, 49 and the ball 50 may be managed based on two coordinate elements.

(15) For example, a game to be carried out in the network game system 10 may be a game other than a soccer game. For example, a game to be carried out in the network game system 10 may be other sport games or action games.

(16) Two or more of the above described modified examples may be combined.

(17) While there have been described what are at present considered to be certain embodiments of the invention, it will be understood that various modifications may be made thereto, and it is intended that the appended claims cover all such modifications as fall within the true spirit and scope of the invention.

What is claimed is:

1. A network game system including a plurality of game devices, for carrying out a game in which a plurality of first game characters which are a plurality of operation targets for a plurality of users and one or more second game characters act, wherein
each of the plurality of game devices comprises
an input accepting section for accepting input of a chat message addressed to one or more users of one or more other game devices;
a transmission section for sending information relating to the chat message input;
a receiving section for receiving information relating to a chat message input in another game device; and
an output control section, in a case where the information relating to the chat message input in the other game device is received, for outputting the chat message,
the network game system comprises
a first game character control section for controlling action of a first game character which is a operation target for a user, based on an operation carried out by the user;
an action control data storage section for storing action control data for use as a basis for action control of the one or more second game characters;
a second game character control section for controlling action of the one or more second game characters, based on the action control data; and
an action control data changing section, in a case where a chat message addressed to one or more users of one or more other game devices is input in any game device, for changing the action control data, based on the chat message.

2. The network game system according to claim 1, wherein the action control data changing section includes a section for changing the action control data, based on the same or similar chat messages, and a number of users having input the same or similar chat messages.

3. The network game system according to claim 1, wherein the action control data changing section includes a section for changing, in a case where a chat message is input in any game device, the action control data for use as a basis for action control of the second game character, based on the chat message and a distance between a first game character, which is an operation target for a user having input the chat message, and the second game character.

4. The network game system according to claim 3, wherein
the action control data changing section includes
a section for restricting change to the action control data for use as a basis for the action control of the second game character in a case where the distance is longer than a reference distance, and
a section for controlling the reference distance, based on a parameter of at least one of the first game character, which is the operation target for the user having input the chat message, and the second game character.

5. The network game system according to claim 1, wherein the action control data changing section includes a section for changing, in a case where a chat message is input in any game device, the action control data for use as a basis for action control of the second game character, based on the chat message and a parameter of at least one of a first game character, which is an operation target for a user having input the chat message, and the second game character.

6. The network game system according to claim 1, wherein
the input accepting section displays a selection screen image for selecting at least one of a plurality of chat messages as the chat message addressed to the one or more users of the one or more other game devices,
the transmission section sends information relating to the chat message selected,
the receiving section receives information relating to a chat message selected in another game device, and
the input accepting section includes a section for displaying, in a case where the information relating to the chat message selected in the other game device is received, distinctly or with priority the chat message or a chat message having a predetermined relationship with the chat message in the selection screen image.

7. The network game system according to claim 1, wherein
the input accepting section displays a selection screen image for selecting at least one of a plurality of chat messages as the chat message addressed to the one or more users of the one or more other game devices,
the transmission section sends information relating to the chat message selected,
the receiving section receives information relating to a chat message selected in another game device, and
the input accepting section includes a section for replacing, in a case where the information relating to the chat message selected in the other game device is received, the chat message or a chat message having a predetermined relationship with the chat message with a predetermined chat message in the selection screen image.

8. The network game system according to claim 1, further comprising a section for evaluating an action of the one or more second game characters after the action control data is changed based on the chat message input in the game device, to thereby evaluate a user having input the chat message,
wherein
the action control data changing section includes a section for changing, in a case where a chat message is input in any game device, the action control data, based on the chat message and an evaluation result on the user having input the chat message.

9. The network game system according to claim 1, further comprising a section for evaluating an action of the one or more second game characters after the action control data is changed based on the chat message input in the game device, to thereby evaluate a user having input the chat message,
wherein
the output control section includes a section for, in a case where information relating to a chat message input in another game device is received, outputting the chat message, based on an evaluation result on the user having input the chat message.

10. The network game system according to claim 1, further comprising
a section for switching the operation target for the user to any of the one or more second game characters; and
a section for restricting, after the action control data is changed based on the chat message input in the game device, switching of the operation target for the user to a second game character engaged in an action corresponding to the chat message.

11. A control method for a network game system for carrying out a game in which a plurality of first game characters operated by a plurality of users and one or more second game characters act, comprising:
a first game character control step of controlling action of a first game character operated by a user, based on an operation carried out by the user;
a step of obtaining from an action control data storage section, for storing action control data for use as a basis for action control of the one or more second game characters, the action control data;
a second game character control step of controlling action of the one or more second game characters, based on the action control data; and
an action control data changing step, in a case where any user of the plurality of users inputs a chat message addressed to one or more other users of the plurality of users, of changing the action control data, based on the chat message.

12. A game control device for controlling a game in which a plurality of first game characters operated by a plurality of users and one or more second game characters act, comprising
a first game character control section for controlling action of a first game character operated by a user, based on an operation carried out by the user;
a section for obtaining from an action control data storage section, for storing action control data for use as a basis for action control of the one or more second game characters, the action control data;
a second game character control section for controlling action of the one or more second game characters, based on the action control data; and
an action control data changing section, in a case where any user of the plurality of users inputs a chat message addressed to one or more other users of the plurality of users, for changing the action control data, based on the chat message.

13. A computer readable information storage medium storing a program for causing a computer to function as a game control device for controlling a game in which a plurality of first game characters operated by a plurality of users and one or more second game characters act, the program for causing the computer to function as:
a first game character control section for controlling action of a first game character operated by a user, based on an operation carried out by the user;
a section for obtaining, from an action control data storage section for storing action control data for use as a basis for action control of the one or more second game characters, the action control data;
a second game character control section for controlling action of the one or more second game characters, based on the action control data; and
an action control data changing section, in a case where any user of the plurality of users inputs a chat message addressed to one or more other users of the plurality of users, for changing the action control data, based on the chat message.
